(19) United States
(12) Patent Application Publication
(10) Pub. No.: US 2004/0227516 A1
(43) Pub. Date: Nov. 18, 2004

(54) Gradient coil for MRT and method for making same

(76) Inventor: Axel Vom Endt, Oxford (GB)

Correspondence Address: SCHIFF HARDIN, LLP, PATENT DEPARTMENT, 6600 SEARS TOWER, CHICAGO, IL, 60606-6473, US

(21) Appl. No.: 10/785,447

(22) Filed: Feb. 24, 2004

(30) Foreign Application Priority Data
Feb. 24, 2003 (DE) 10307814.2

(51) Int. Cl. G01V 3/00

(52) U.S. Cl. 324/318

(57) ABSTRACT

In a method to produce a gradient coil for use in magnetic resonance tomography, suitable for producing planar coils, saddle coils. a spiral coil is arranged on a first surface with an inner conductor feed section and an outer conductor feed section of the coil, with the inner conductor feed arranged on a second surface separated from the first surface. The coil, together with its conductor feed sections, a continuous unitary electrical conductor. The inner conductor feed is arranged outside of the carrier plate.

### BACKGROUND OF THE INVENTION

1. Field of the Invention

The present invention concerns in general a method to produce a gradient coil for use in a magnetic resonance tomography (MRT system). The present invention in particular concerns a technique to produce planar coils or saddle coils.

2. Description of the Prior Art

MRT is based on the physical phenomenon of nuclear magnetic resonance and has been successfully used as an imaging modality in medicine and biophysics for over 15 years. In this examination modality, the subject is exposed to a strong, constant basic magnetic field. The nuclear spins of the atoms of the subject, which were previously oriented irregularly, thereby align. Radio-frequency energy can now excite these “ordered” nuclear spins to a specific oscillation (resonance frequency). This oscillation generates the actual measurement signal (RF response signal) in MRT, which is acquired by means of suitable receiver coils.

Having exact information about the respective point of origin of the RF response signal is a requirement for the image reconstruction. This spatial information is acquired by magnetic fields (magnetic gradient fields) that are present, in addition to the basic static magnetic field along the three spatial directions. These gradient fields are small in comparison to the basic field and are generated by additional resistance coils in the patient opening of the magnet. Due to these gradient fields, the total magnetic field, and therewith the resonant frequency as well, is different in each volume element. If RF energy at a defined resonant frequency is emitted into the subject, only the atomic nuclei that are located at a point at which the magnetic field fulfills the corresponding resonance requirement can be excited. Suitable changes of the gradient fields enable the location of such a volume element in which the resonance requirement is fulfilled to be shifted in a defined manner, and thus enable the desired region to be scanned.

The gradient fields along all three spatial directions are generated by three different windings (known as gradient coils) that form the gradient system. Each gradient coil generates a gradient field that is proportional to the current supplied to the coil. The gradient fields are respectively perpendicular to one another. A differentiation is made between planar gradient coils in open MRT systems (for example, the Magnetom® Openmodel, offered by Siemens AG) and cylindrical gradient coils (Maxwell coils) or, respectively, partially cylindrical gradient coils (saddle coils) in closed MRT systems (for example, the Magnetom® Vision offered by Siemens AG).

The cylindrical gradient coil (Maxwell coil) is a common cylinder coil that generates an axial field that varies in the radial direction. The production of such a coil ensues by winding an electrical conductor on a cylinder surface in the axial direction.

The planar gradient coils as well as the saddle coils exhibit a pretzel-shaped or, respectively, spiral-like conductor structure. The conventional production of such coils ensues by insertion of the conductor into a suitable (pretzel-shaped or spiral-shaped) molded form or into recesses of a planar winding plate and subsequent bonding of the thusly generated pretzel-shaped or spiral-shaped conductor path to a carrier plate which, ultimately, is lifted from the winding plate. The carrier plate is rolled to a desired radius to generate saddle coils. This step is designated as “reforming” or “rolling”.

According to the present production method of planar gradient coils and saddle coils, it is not possible to generate a continuous winding, since an external connection (terminal) via which the coils can be electrically connected must be achieved from the inside of each spiral winding (also called an “eye”). This connection is produced in the final assembly of the gradient coil—in saddle coils after the rolling—by soft soldering items known as “inner (solder) connectors”. This has several disadvantages. Such solder connectors typically are implemented as molded (and therefore expensive) individual parts. The soldering as such represents an elaborate method step in the production process of planar gradient coils and saddle coils. Furthermore, solder points are always potential failure sources, since the solder point can break or the electrical resistance can be increased given poor soldering. Moreover, solder balls that occur in the soldering can cause short circuits in subsequent operation.

A gradient coil system for a magnetic resonance tomography system is known from the German published patent specification German OS 39 38 167 corresponding to U.S. Pat. Nos. 5,012,191 and 5,012,192 that has a number of saddle coils for the X-gradient and the Y-gradient. The windings of the saddle coils for the X-gradient and the Y-gradient are arranged in the winding bed of a hollow-cylindrical body. The saddle coils respectively associated with a field gradient have a single common cable conductor, such that it is possible to achieve a gradient coil system with four saddle coils without intermediary contacts. For this, underpasses for the conductor are provided at a number of locations of the saddle coils. Furthermore, the document German OS 39 38 167 discloses a method to produce a gradient coil system by using a hollow-cylindrical body having a winding bed.

A method to produce a gradient coil arrangement for an MRI apparatus is specified in the German OS 40 17 260. According to this document, saddle coils are produced by inserting wires into grooves of a first form, such that the spatial arrangement of the saddle coils is determined by the position of the grooves. A fabric immersed in an adhesive is subsequently pressed on the wiring by another form. The adhesive is subsequently hardened (curved) so that the fabric adheres to the wiring. In this manner, a saddle coil arrangement is formed that includes the fabric and the wiring.

The German OS 42 32 882 discloses a device to wind so-called fingerprint coils that has a plate that can be rotated around the innermost point of the windings of a fingerprint coil. Pins that define the deviation points for the windings can be affixed in the plate at fixed locations. Furthermore, a supply device is provided with which a conductor of the rotatable plate can be tangentially supplied.

### SUMMARY OF THE INVENTION

It is an object of the present invention to improve or to simplify the conventional design assembly as well as the production method of gradient coils.

This object is achieved according to the invention by a gradient coil for an magnetic resonance tomography apparatus having a spiral coil arranged on a first surface with inner and outer conductor feed section of the coil, wherein the inner conductor feed section is arranged on a second surface separated from the first surface. The coil with its conductor feed is a continuous unitary electrical conductor. The conventional common use of soldered, expensive inner connectors is thereby dispensed with. The inner conductor feed section is inventively arranged outside of the carrier plate.

The coil can be affixed to a carrier plate.

If inventive gradient coil is to be fashioned as a planar coil, the first surface represents a plane.

Given a fashioning of the gradient coil as a saddle coil, the first surface represents a cylindrical surface.

The above object also is achieved in accordance with the invention by a method to produce a gradient coil, including the steps of insertion of a part of an electrical conductor into a groove of a winding plate having the form of a spiral coil arranged on a first surface, adhesion of the thusly formed conductor path arrangement with a carrier plate, lifting off the carrier plate from the winding plate, and from the winding plate bending of a part of the electrical conductor remaining in the coil center into a second surface, such that a radial inner conductor feed section is created.

The thusly-generated gradient coil is planar with a free radial inner feed section.

The above object is also achieved in accordance with the invention by a method to produce a gradient coil including the steps of generation of a radial inner conductor feed section by inserting a part of an electrical conductor into a predetermined groove of a winding plate lying in a first plane, further insertion of the electrical conductor into a predetermined spiral-shaped groove of the winding plate directed outwardly and lying in a second plane, whereby the first plane comes to lie under the second plane, adhesion of the thusly formed conductor path arrangement to a carrier plate, and lifting off the carrier plate from the winding plate.

The thusly-generated gradient coil is likewise planar, however, the radial inner conductor feed section is integrated into the carrier plate.

Both embodiments of the planar gradient coil can be reformed into saddle coils with a further method step, such as rolling the coil on a cylindrical surface, with the inner conductor feed section being aligned parallel to the cylinder axis.

### DESCRIPTION OF THE DRAWINGS

FIG. 1a is a perspective view of a planar gradient coil (or a saddle coil before rolling), with free feed section of the connection wire in accordance with the invention.

FIG. 1b is a section through the winding plate of the planar gradient coil of FIG. 1a, taken along line A-A.

FIG. 2a is a perspective view of a planar gradient coil (or a saddle coil before rolling) with an integrated feed section of the connection wire in accordance with the invention.

FIG. 2b is a section through the winding plate of the planar gradient coil of FIG. 2a, taken along line B-B.

FIG. 2c is a section through the winding plate of the planar gradient coil of FIG. 2a, taken along line C-C.

FIG. 3 is a perspective view of a two-part saddle coil in accordance with the invention, with feeding of the connecting wire at a smaller radius, FIG. 4 is a perspective view of a two-part saddle coil in accordance with the invention with feeding of the connecting wire at a larger radius.

### DESCRIPTION OF THE PREFERRED EMBODIMENTS

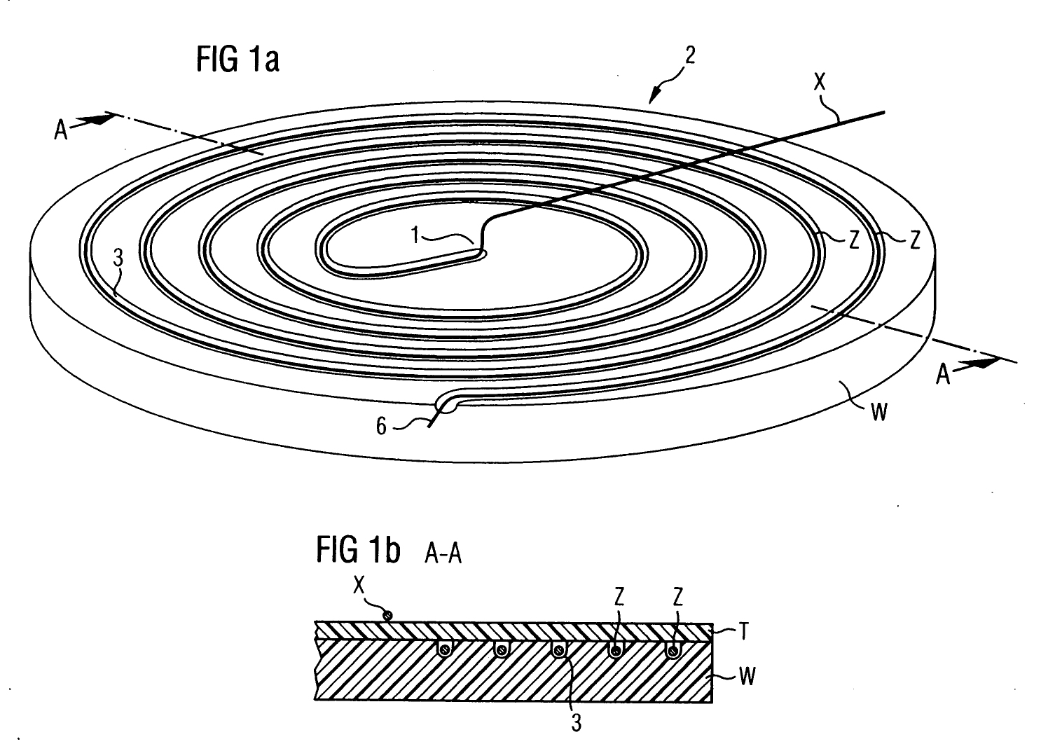

FIG. 1a is a perspective view of a first embodiment of the inventively completely through-wound planar gradient coil (or saddle coil before the rolling). The coil is shown as a rounded spiral 2 that exhibits a center 1 (also called an eye) in the middle. The term “completely through-wound”, means a continuous conductor path arrangement in which radial connection X from the interior to the exterior is achieved from the inside (the eye 1) of the spiral 2 without a solder connection. The radial connection X (conductor feed) outwardly naturally cannot ensue on the same plane as the spiral, but rather is disposed in the planar gradient coil in a surface above or below the coil plane; in a saddle coil it is disposed on a cylindrical surface with a larger or smaller radius. The inner conductor feed X is achieved in that the winding of the spiral from the inside out does not begin with the conductor end, but rather a suitably long conductor piece is kept free which is ultimately curved or bent over the spiral after the winding. Given the winding of the spiral from the outside in, in a last step enough electrical conductor is added so that a radial conductor feed X (inner conductor feed) can be realized over the entire spiral 2 by bending the conductor end at the eye 1. It should be noted that the spiral coil form alternatively can be polygonal (with angles) in particular also pretzel-shaped given planar gradient coils.

In this first embodiment according to FIG. 1a, the feeding of the conductor X (inner conductor feed) ensues above the coil plane. The procedure to produce a conductor path arrangement according to FIG. 1a includes placing the conductor in the corresponding spiral groove 3 of a winding plate W, either from the inside out or from the outside in. The outer conductor path end 6 of the coil is correspondingly located in the coil plane, while the inner conductor path end X (inner conductor feed) is initially aligned axial to the coil plane. The coil thus achieved is adhered to a carrier plate T after the end of the winding and is lifted off the winding plate W. In the production of a planar gradient coil, the inner conductor path end X (inner conductor feed) is subsequently bent, such that it proceeds freely outwardly from the coil region at a slight, uniform spacing from the coil plane. Finally, the curved conductor path end X (inner conductor feed) is either sealed with the planar coil part Z or is temporarily affixed to it with suitable adhesive in the final assembly. Shown in FIG. 1b in the section A-A through the winding plate W and through the carrier plate T is the relative position of the conductor paths X and Z of a planar gradient coil to be finished according to FIG. 1a. The inner conductor path end C (inner conductor feed) is directed radially outwardly, just above the carrier plate T.

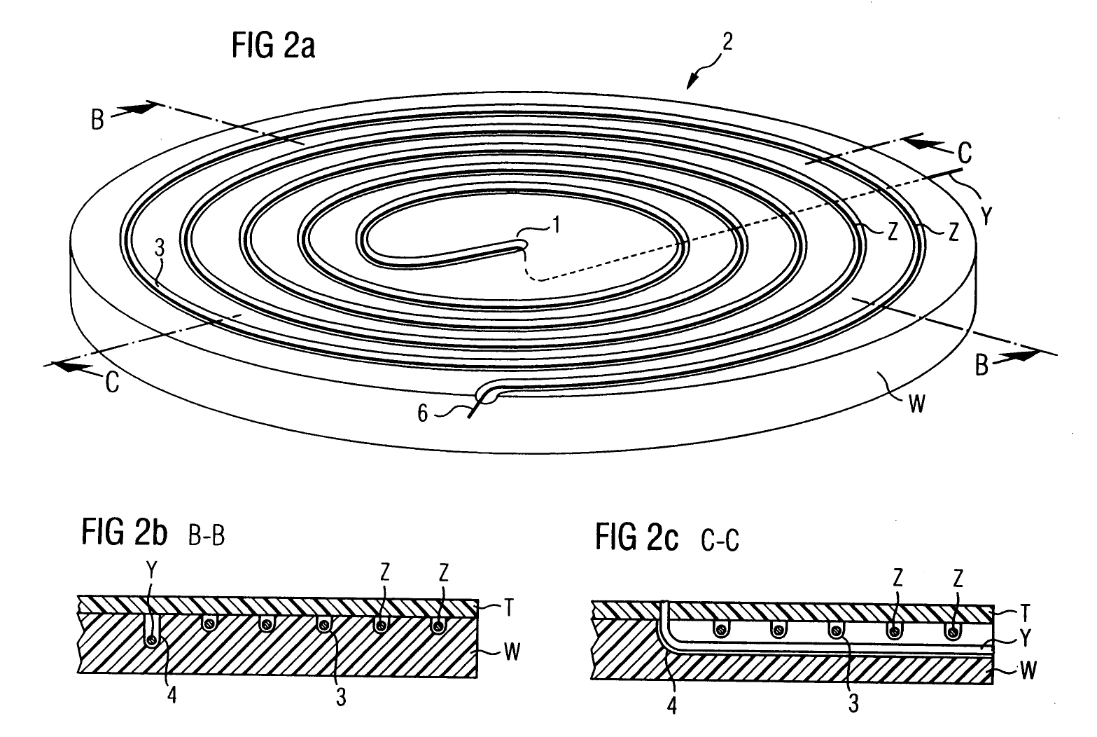

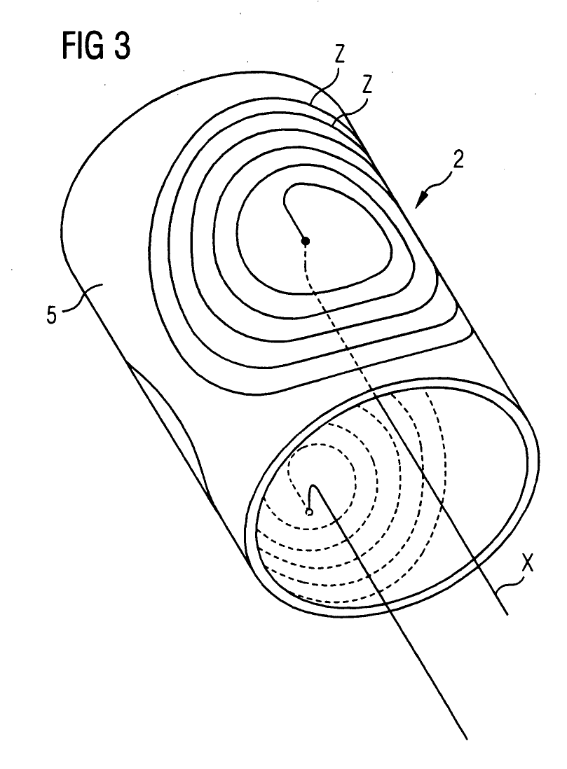

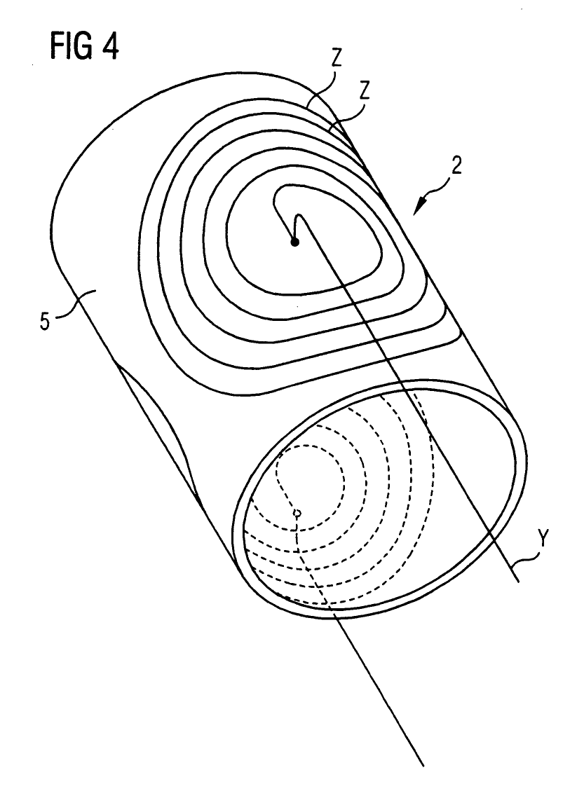

FIG. 2a is a perspective view of a second embodiment of the inventive, completely through-wound planar gradient coil (or saddle coil before rolling). The conductor feed Y (inner conductor feed) to the coil center 1 ensues according to FIG. 2a in a plane below the spirally arranged conductor paths Z. The procedure to produce a conductor path arrangement according to FIG. 2a is to initially achieve a radial conductor feed Y (inner conductor feed) to the coil center in which the feeding conductor Y is placed in a groove 4 of the winding plate W that is placed deeper relative to the grooves for the actual magnetic field-generating coil spiral. The planar coil part Z is then generated by placing the conductor in the higher-placed spiral grooves of the winding plate W from the center 1 out, such that the outer coil end 6 (outer conductor feed) comes to lie in the coil plane and the inner feed Y comes to lie under the coil plane. The conductor path arrangement thus created is affixed by lamination to a carrier plate that is ultimately lifted off of the winding plate W. The relative position of the conductor paths Y, Z to one another, in particular the conductor path feed Y to the coil center 1, is shown in FIGS. 2b and 2c in sections perpendicular to one another. Section B-B shows the feed to coil center 1 placed deeper in the winding plate W in comparison to the spiral grooves. The section C-C perpendicular to slice B-B shows the conductor path feed Y to the coil center 1 under the actual spiral placed conductor paths Z. This conductor path arrangement is already completely affixed to the carrier plate T after the lamination.

In both embodiments, an inner connection, and thus soldering, is foregone in the sensitive region of the coil center 1, which simplifies the manufacturing process as well as eliminating a potential failure source.

In principle, both of the embodiments of the planar coils described above can be used to produce two-part or multi-part saddle coils that deliver orthogonal gradient fields given corresponding mutual arrangement and circuiting. In the production of a saddle coil, the carrier plate T of the first or second embodiment is curved or rolled in such a manner that it forms the part of a cylindrical surface 5. By 90° or 180° displacement (rotation around the cylinder axis) of four thusly fashioned saddle coils, two transverse gradient fields that are orthogonal to one another can be generated that are both in turn orthogonal to the axial gradient field of the already mentioned Maxwell coil (z-coil) of a closed MRT system. It should be noted that in each saddle coil, the conductor feed X from the coil center according to the first inventive embodiment or the conductor feed Y to the coil center 1 according to the second inventive embodiment runs exactly parallel to the cylinder axis of the thusly fashioned cylindrical gradient (coil) system in order to produce no axial field components; which would influence the linearity of the Maxwell coil and thus cause image distortions.

A two-part saddle coils are respectively shown in FIGS. 3 and 4. For clarity, only the conductor path arrangement is shown. The respective carrier plates are not shown, or are to be regarded as transparent. FIGS. 3 and 4 differ in the manner of the conductor feed to and from the coil center. FIG. 4 shows a two-part saddle coil with two conductor feeds Y, parallel to the cylinder axis, that have a larger separation from the cylinder axis than the coil itself. In FIG. 3, it is the reverse: both conductor feeds X are located on a cylindrical surface with a smaller radius than that of the coils. Naturally, it is also possible to combine both conductor feed types in a two-part saddle coil. Since the carrier plates are not indicated in FIGS. 3 and 4, the drawings are non-specific as to whether the conductor feed is free or is integrated into the carrier plate. Both or a combination of the above embodiments are/is conceivable. In both FIGS. 3 and 4 the conductor feed proceeds exactly parallel to the cylinder axis in order to not influence the axial gradient field of the Maxwell coil (not shown).

As already mentioned, the production of such saddle coils can ensue by rolling of the carrier plate of the first or second embodiment. Another possibility for the production is to already implement the winding plate in the first or second embodiment as a cylindrical winding form with the desired radius. In both cases, the soldering of an inner connector is foregone, and thus the coil can be continuously wound. The process step of rolling is dispensed with.

Although modifications and changes may be suggested by those skilled in the art, it is the intention of the inventor to embody within the patent warranted hereon all changes and modifications as reasonably and properly come within the scope of his contribution to the art.

I claim as my invention:

1. A gradient coil for a magnetic resonance tomography apparatus comprising:
a carrier plate;
a spiral coil disposed on said carrier plate at a first level relative to said carrier plate;
said coil having an inner conductor feed section and an outer conductor feed section, said inner conductor feed section being disposed at a second level, separated from said first level, relative to said carrier plate, and said spiral coil with said inner and outer feed conductor sections forming a continuous, unitary electrical conductor; and
said inner conductor feed section being disposed outside of said carrier plate.

2. A gradient coil as claimed in claim 1 wherein said first level is a plane.

3. A gradient coil as claimed in claim 1 wherein said first level is a cylindrical surface.

4. A method for producing a gradient coil for a magnetic resonance tomography apparatus comprising the steps of:
providing a winding plate having a continuous groove therein in the form of a spiral disposed in a first plane;
inserting a portion of a continuous electrical conductor into said groove for causing said continuous electrical conductor to follow said groove along said conductor path to generate a conductor arrangement formed as a spiral coil in said first plane;
adhering said spiral coil to a carrier plate;
lifting the carrier plate from said winding plate; and
bending a portion of said continuous electrical conductor remaining in a center of said spiral coil into a second plane, thereby forming a radial inner conductor feed section.

5. A method as claimed in claim 4 comprising rolling said spiral coil to form a hollow cylinder having a cylinder axis, and aligning said inner conductor feed section parallel to said cylinder axis.

6. A method for producing a gradient coil for a magnetic resonance tomography apparatus comprising the steps of:
providing a winding plate having a predetermined groove in a first plane, and a predetermined spiral-shaped groove proceeding outwardly from a center and being disposed in a second plane, said first plane being disposed below said second plane;
inserting a continuous electrical conductor into said predetermined groove and into said spiral-shaped groove and thereby forming, in said predetermined groove, a radial inner conductor feed section in said first plane and forming, in said spiral-shaped groove, a spiral coil in said second plane, said spiral coil and said inner conductor feed section forming a conductor arrangement;
adhering said conductor arrangement to a carrier plate adhering said conductor arrangement to a carrier plate disposed on said winding plate; and
lifting said carrier plate together with said conductor arrangement off of said carrier plate.

7. A method as claimed in claim 6 comprising rolling said spiral coil to form a hollow cylinder having a cylinder axis, and aligning said inner conductor feed section parallel to said cylinder axis.
